(19) United States
(12) Patent Application Publication
(10) Pub. No.: US 2006/0216561 A1
(43) Pub. Date: Sep. 28, 2006

(54) HEAT DISSIPATION ASSEMBLY

(76) Inventors: Yang-Chang Chien, Shenzhen (CN); Chuan-De Huang, Shenzhen (CN)

Correspondence Address: NORTH AMERICA INTELLECTUAL PROPERTY CORPORATION, P.O. BOX 506, MERRIFIELD, VA, 22116, US

(21) Appl. No.: 11/306,491

(22) Filed: Dec. 29, 2005

(30) Foreign Application Priority Data
Mar. 25, 2005 (CN) 200510033851.7

(51) Int. Cl. H01M 8/04; H01M 8/10; H01M 8/08

(52) U.S. Cl. 429/26; 429/34; 429/30; 429/46

(57) ABSTRACT

This invention relates to a heat dissipation assembly for dissipating heat generated by a heat-generating device. The heat dissipation assembly includes a first heat dissipation device, a heat transferring member, a second heat dissipation device, and a fuel cell having a cell base and a fuel cartridge for supplying fuel for the cell base. The first heat dissipation device is configured for absorbing heat from the heat-generating device. The second heat dissipation device is connected to the first heat dissipation device via the heat transferring member, and is configured for absorbing heat absorbed by the first heat dissipation device. The fuel cartridge of the fuel cell is thermally contacted with the second heat dissipation device.

### FIELD OF THE INVENTION

This invention relates to a heat dissipation assembly, and more particularly, to a heat dissipation assembly having heat-recycling function.

### DESCRIPTION OF RELATED ART

Electronic systems, such as computer systems, usually employ a number of electrical components that generate heat. Excessive heat accumulated therein will adversely affect operation of the computer system, and may cause the computer system to be unstable. Therefore, heat dissipation assemblies are widely used for dissipating heat from heat-generating devices of a computer system to outside thereof. Typically, a heat dissipation assembly such as a heat sink is disposed on the heat-generating device for heat dissipation.

Nowadays, developments in computer chip technology have provided computer central processing units (CPUs) with more functions and faster processing speeds. Accordingly, modern CPUs generate copious amounts of heat. Generally speaking, a heat-generating quantity of a CPU is in a range from 50 to 90 Watts, which results a surface temperature of the CPU of approximately 40 to 80 degrees Celsius. For example, the heat-generating quantity of a Pentium IV 2.8 G CPU is about 68 Watts, and a surface temperature of the CPU configured with a conventional heat dissipation assembly is about 70 degrees Celsius. Such a high surface temperature may adversely affect operation of the computer system, thus a heat dissipation assembly having very high heat dissipation efficiency is becoming increasingly important.

In another aspect, fuel cells are more and more popular as a green energy source, particularly for portable electronic devices. Compared with the secondary cells which need a considerable time to recharge, the fuel cells have advantages of continuous power supply and quick refilling of fuel. A fuel cell is an electrochemical device for continuously converting chemical energy into electrical energy at a suitable reaction temperature. Currently, fuel cells can be classified into proton exchange membrane fuel cells (PEMFCs), alkaline fuel cells (AFCs), direct methanol fuel cells (DMFCs), etc. Generally, a fuel cell includes a cell base, a fuel cartridge for supplying fuel to the cell base, and an external heater for heating the fuel up to a reaction temperature, which is approximately in a range from 50 to 120 degrees Celsius. The cell base generally includes an anode, a cathode, an electrolyte sandwiched therebetween, and an external circuit connected to the anode and the cathode. The fuel is fed to the anode, and an oxidizer is fed to the cathode. However, the external heater consumes an amount of electrical energy, thereby an energy utilization efficiency of the fuel cell is lowered in a sense.

What is needed, therefore, is to provide a heat dissipation assembly, which has an excellent heat dissipating efficiency, and an improved energy utilization efficiency associated therewith.

### SUMMARY OF THE INVENTION

A preferred embodiment provides a heat dissipation assembly for dissipating heat generated by a heat-generating device. The heat dissipation assembly includes: a first heat dissipation device, a heat transferring member, a second heat dissipation device, and a fuel cell having a cell base and a fuel cartridge for supplying fuel for the cell base. The first heat dissipation device is configured for absorbing heat from the heat-generating device. The second heat dissipation device is connected to the first heat dissipation device via the heat transferring member, and is configured for absorbing heat absorbed by the first heat dissipation device. The fuel cartridge of the fuel cell is thermally contacted with the second heat dissipation device.

Compared with the conventional heat dissipation assemblies, a heat dissipation assembly in accordance with the present invention is characterized by configuring with a fuel cell. In one aspect, the fuel cell acts as a heat absorber, which can accelerate the heat dissipation of the heat dissipation assembly; in another aspect, the fuel cell need not configure with an additional external heater, which can achieve waste heat recovery by absorbing waste heat generated by the heat-generating device, and enhance energy utilization efficiency thereof.

Other advantages and novel features will become more apparent from the following detailed description of embodiments when taken in conjunction with the accompanying drawing.

### BRIEF DESCRIPTION OF THE DRAWINGS

Many aspects of the heat dissipation assembly can be better understood with reference to the following drawing. The components in the drawing are not necessarily to scale, the emphasis instead being placed upon clearly illustrating the principles of the present heat dissipation assembly. Moreover, in the drawing, like reference numerals designate corresponding parts throughout the several views.

FIG. 1 is schematic, isometric view illustrating a heat dissipation assembly in accordance with a preferred embodiment of present invention.

The exemplifications set out herein illustrate at least one preferred embodiment of the invention, in one form, and such exemplifications are not to be construed as limiting the scope of the invention in any manner.

### DETAILED DESCRIPTION

Reference will now be made to the drawing figure to describe the present invention in detail.

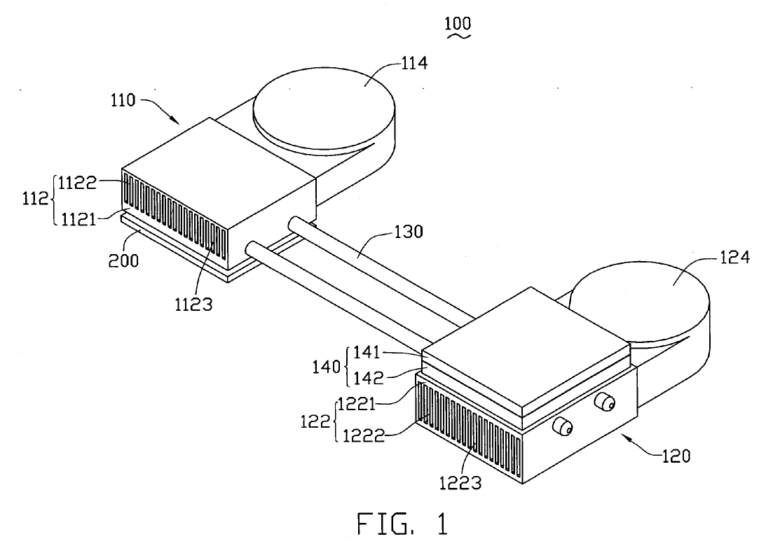

Referring to FIG. 1, a heat dissipation assembly 100 according to a preferred embodiment is shown. The heat dissipation assembly 100 includes a first heat dissipation device 110, a second heat dissipation device 120, at least one heat transferring member 130, and a fuel cell 140.

The first heat dissipation device 110 includes a heat sink 112. The heat sink 112 includes a base 1121 and a plurality of fins 1122 extending upwardly from an upper surface of the base 1121. The base 1121 is generally brought into contact with a heat-generating device 200, such as a CPU. Advantageously, the fins 1122 are regularly distributed on the base 1121. Each of the fins 1122 extends perpendicularly from the upper surface of the base 1121. Every two adjacent fins 1122 define an airflow channel 1123 therebetween. The heat sink 112 can be made of thermally conductive materials, such as aluminum, copper, etc. Preferably, a fan 114 is optionally disposed on the heat sink 112 for facilitating heat dissipation. The fan 114, if employed, can accelerate heat dissipation. It is to be understood, the heat sink 112 is not limited to the above-described shape and configuration. For example, a heat slug without the fan 114 attached thereto may be used instead.

The second heat dissipation device 120 is spaced apart from the heat-generating device 200, and includes a heat sink 122. The heat sink 122 includes a base 1221 and a plurality fins 1222 extending downwardly from a lower surface of the base 1221. Advantageously, the fins 1222 are regularly distributed on the base 1221 Each of the fins 1221 extends perpendicularly from the lower surface. Every two adjacent fins 1221 define an airflow channel therebetween. The heat sink 122 can be made of thermally conductive materials, such as aluminum, copper, etc. Preferably, a fan 124 is disposed on a lateral side of the heat sink 122 for facilitating heat dissipation. The fan 124 is configured for accelerating heat dissipation of the heat sink 122.

The heat transferring member 130 is configured for connecting the first heat dissipation device 110 and the second heat dissipation device 120. In this embodiment, two heat pipes are used as the heat transferring members 130. Each of the heat pipes includes an evaporating portion, and a condensing portion. In the illustrated embodiment, the evaporating portion of each of the heat pipes penetrates through the fins 1122 of the heat sink 112, and the condensing portion penetrates through the fins 1222 of the heat sink 122.

The fuel cell 140 is in thermally contact with the second heat dissipation device 120. The fuel cell 140 includes a cell base 141 and a fuel cartridge 142 for supplying fuel to the cell base 141. The cell base 141 is a cell that capable of directly converting chemical energy into electrical energy. The fuel cartridge 142 can be disposed on an upper surface of the base 1221 of the second heat dissipation device 120, thereby the fuel cartridge 142 is in thermally contact with the base 1221. The fuel cell 140 is generally one of a proton exchange membrane fuel cell, a direct methanol fuel cell, and an alkaline fuel cell.

A heat dissipating process of the heat dissipation assembly 100 is described as follow: The base 1121 of the heat sink 112 absorbs heat generated by the heat-generating device 200. Part of the heat is transferred to the fins 1122 of the heat sink 112 and is then dissipated thereby; the other part of the heat is transferred to the second heat dissipation device 120 via the heat transfer members 130. The heat transferred by the heat transfer members 130 is absorbed by the base 1221 of the heat sink 122. Part of the heat is transferred to the fins 1222 and is then dissipated thereby, the other part of the heat is provided to the fuel cell 124. Then, a fuel stored in the fuel cartridge 142 is heated up to a reaction temperature, and is supplied continuously to the cell base 141 by a pump (not shown). The fuel reacts with an oxidizer in the cell base 141, thereby generating electric energy. The electric energy can be provided to an electronic device, e.g. a portable electronic device. Thus the heat-generating device 200 is used as a power supply for the electronic device. In the heat dissipating process of heat dissipation assembly 100, a reaction temperature of the fuel cell 140 is achieved by means of the heat-generating device 200. Hence, there is no need to employ an additional external heater.

As stated above, the fuel cell 140 of the heat dissipation assembly 100 acts as a heat absorber, which accelerates the heat dissipation of the heat dissipation assembly. Therefore, the heat dissipation assembly 140 can attain a faster and excellent heat dissipation efficiency, and a high energy utilization efficiency.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A heat dissipation assembly for dissipating heat generated by a heat-generating device, the heat dissipation assembly comprising:
a first heat dissipation device configured for absorbing heat from the heat-generating device;
a heat transferring member;
a second heat dissipation device connected to the first heat dissipation device via the heat transferring member, the second heat dissipation device being configured for absorbing heat absorbed by the first heat dissipation device; and
a fuel cell having a cell base and a fuel cartridge for supplying fuel to the cell base body, the fuel cartridge being in thermally contact with the second heat dissipation device.

2. The heat dissipation assembly of claim 1, wherein the first heat dissipation device comprises a first heat sink.

3. The heat dissipation assembly of claim 2, wherein the first heat dissipation device further comprises a first fan disposed on the first heat sink.

4. The heat dissipation assembly of claim 1, wherein the second heat dissipation device comprises a second heat sink.

5. The heat dissipation assembly of claim 4, wherein the second heat dissipation device further comprises a second fan disposed on a lateral side of the second heat sink.

6. The heat dissipation assembly of claim 1, wherein the heat transfer member comprises an evaporating portion and a condensing portion opposite thereto, the evaporating portion being thermally connected with the first heat dissipation device, the condensing portion being thermally connected with the second heat dissipation device.

7. The heat dissipation assembly of claim 6, wherein the heat transfer member is a heat pipe.

8. The heat dissipation assembly of claim 1, wherein the fuel cell is selected from the group consisting of a proton exchange membrane fuel cell, a direct methanol fuel cell and an alkaline fuel cell.
